(19) United States
(12) Patent Application Publication
(10) Pub. No.: US 2016/0349508 A1
(43) Pub. Date: Dec. 1, 2016

(54) DISPLAY APPARATUS

(71) Applicant: OLYMPUS CORPORATION, Tokyo (JP)

(72) Inventor: Yoshiaki HORIKAWA, Tokyo (JP)

(73) Assignee: OLYMPUS CORPORATION, Tokyo (JP)

(21) Appl. No.: 15/231,901

(22) Filed: Aug. 9, 2016

Related U.S. Application Data
(63) Continuation of application No. PCT/JP2014/005546, filed on Nov. 4, 2014.

(30) Foreign Application Priority Data
Feb. 26, 2014 (JP) 2014-035703

(51) Int. Cl. G02B 27/01; G03H 1/22; G02B 27/28

(52) U.S. Cl. CPC G02B 27/0103; G02B 27/283; G03H 1/2205; G03H 1/2294; G03H 2223/16; G03H 2225/32; G03H 2223/20; G03H 2223/23; G03H 2223/18

(57) ABSTRACT

A display apparatus includes a spatial phase modulator that forms a display light beam, a transparent substrate in which the display light beam propagates by repeated internal reflection, a bifurcation that emits a portion of the display light beam outside the transparent substrate each time the display light beam undergoes the internal reflection, and a light beam introduction optical system including a beam splitter that guides an illumination light beam to the spatial phase modulator and guides the display light beam formed by the spatial phase modulator to the transparent substrate. The spatial phase modulator forms the display light beam holographically by diffraction of the illumination light beam.

### CROSS-REFERENCE TO RELATED APPLICATION

The present application is a Continuing Application based on International Application PCT/JP2014/005546 filed on Nov. 4, 2014, which in turn claims priority to Japanese Patent Application No. 2014-035703 filed on Feb. 26, 2014, the entire disclosure of these earlier applications being incorporated herein by reference.

### TECHNICAL FIELD

This disclosure relates to a display apparatus.

### BACKGROUND

In recent years, an image display apparatus for forming a virtual image of a display screen in front of an observer has been proposed. Japanese patent No. 4,605,152 discloses an image display apparatus of this type in which a display light beam is repeatedly subjected to internal reflection within a transparent substrate to propagate the display light beam within the substrate. Each time the display light beam undergoes internal reflection, a portion of the display light beam is emitted outside the substrate, thereby emitting the display light beam from nearly the entire surface of the substrate.

In greater detail, in this image display device, a display light beam is emitted from a display screen of a liquid crystal display element. The display light beam emitted from the display screen is converted by an objective lens to a parallel light beam and is incident on a transparent substrate. The display light beam propagates through the transparent substrate while repeatedly undergoing internal reflection in the transparent substrate. At this time, upon each internal reflection, a portion of the display light beam is emitted outside the substrate, so that the display light beam is emitted from a plurality of positions in the transparent substrate. Therefore, the display light beam is emitted from the entire surface of the transparent substrate. As a result, the overall diameter of the display light beam emitted from the transparent substrate is larger than the diameter of the light beam incident on the transparent substrate.

For the observer to observe a virtual image of the display screen, the display light beam emitted from the transparent substrate needs to enter the eye. In the aforementioned display apparatus, the diameter of the display light beam emitted from the transparent substrate is large (thick). Therefore, the allowable range for aligning the eye with the display light beam (transparent substrate) is greater than when the diameter of the display light beam is small (thin). As a result, the observer can easily observe the virtual image.

The display light beam emitted from the transparent substrate is a parallel light beam. Therefore, the observer can observe a virtual image located behind the transparent substrate. Since the display light beam is thick, the observer does not need to place the eye near the display apparatus. “Behind the transparent substrate” refers to a position that is on the opposite side of the transparent substrate from the observer.

### SUMMARY

A display apparatus according to this disclosure includes:

a spatial phase modulator configured to form a display light beam;

a transparent substrate, the display light beam propagating in the transparent substrate by repeated internal reflection;

a bifurcation configured to emit a portion of the display light beam outside the transparent substrate each time the display light beam undergoes the internal reflection; and

a light beam introduction optical system including a beam splitter configured to guide an illumination light beam to the spatial phase modulator and to guide the display light beam formed by the spatial phase modulator to the transparent substrate; wherein

the spatial phase modulator forms the display light beam holographically by diffraction of the illumination light beam.

The light beam introduction optical system may have a lens power of zero in an optical path of the display light beam between the spatial phase modulator and the transparent substrate.

The light beam introduction optical system may further include an optical element with a negative lens power in an optical path of the display light beam between the spatial phase modulator and the transparent substrate.

The light beam introduction optical system may have a negative lens power in an optical path of the display light beam between the spatial phase modulator and the transparent substrate.

The beam splitter may include a polarizing beam splitter; and

the light beam introduction optical system may further include a quarter-wavelength plate between the polarizing beam splitter and the spatial phase modulator.

The light beam introduction optical system may cause the illumination light beam to be incident on the spatial phase modulator by inclining a central light ray of the illumination light beam relative to a normal to the spatial phase modulator.

An angle of reflection of zero-order light of the illumination light beam at the spatial phase modulator may be greater than half of one display angle of view due to the display light beam.

Zero-order light of the illumination light beam at the spatial phase modulator may be removed in a direction in which an angle of view is narrow.

A coherence length of the display light beam may be shorter than a distance of propagation of the display light beam due to undergoing the internal reflection once.

The display light beam emitted outside the transparent substrate may display a virtual image at infinity.

Zero-order light and first-order light due to the spatial phase modulator may be incident on the transparent substrate under a condition of zero-order light passing through the transparent substrate and the first-order light being totally reflected within the transparent substrate.

The bifurcation may be a diffraction grating.

The diffraction grating may be a volume hologram.

The bifurcation may be a prism array.

The display apparatus may further include a second transparent substrate, on which the display light beam emitted from the transparent substrate is incident, configured to propagate the display light beam by repeated internal reflection of the display light beam; and

a second bifurcation configured to emit a portion of the display light beam outside the second transparent substrate each time the display light beam undergoes the internal reflection in the second transparent substrate.

### BRIEF DESCRIPTION OF THE DRAWINGS

in the accompanying drawings:

FIG. 1A illustrates the basic structure of the display apparatus and propagation of a display light beam when a diverging illumination light beam is caused to enter the transparent substrate;

FIG. 1B illustrates the basic structure of the display apparatus and propagation of a display light beam when a parallel illumination light beam is caused to enter the transparent substrate;

FIG. 2A is a diagram illustrating a regular optical system when observing a virtual image;

FIG. 2B illustrates a method and apparatus for holographically forming a display light beam;

FIG. 3 is a block diagram illustrating processing when providing a hologram by calculation;

FIG. 4 schematically illustrates the structure of a display apparatus according to Embodiment 1;

FIG. 5 is a partial detail drawing of the light beam introduction optical system in FIG. 4;

FIG. 6 schematically illustrates the structure of a display apparatus according to Embodiment 2;

FIG. 7 schematically illustrates the structure of a display apparatus according to Embodiment 3;

FIG. 8 is a partial detail drawing of the light beam introduction optical system in FIG. 7;

FIG. 9 schematically illustrates the structure of a display apparatus according to Embodiment 4;

FIG. 10 illustrates the display area of Embodiment 4;

FIG. 11 schematically illustrates the structure of a display apparatus according to Embodiment 5;

FIG. 12 illustrates the structure of the second transparent substrate in FIG. 11 and propagation of a display light beam; and

FIG. 13 illustrates the optical distance of light beams emitted from the display apparatus of FIG. 11.

### DETAILED DESCRIPTION

First, before describing embodiments of this disclosure, the principle behind image display by a display apparatus according to this disclosure is described.

The display apparatus according to this disclosure holographically forms a display light beam. The display light beam is generated by diffraction and propagates by repeated internal reflection within a transparent substrate, and a portion of the display light beam is emitted outside the transparent substrate upon each internal reflection. By propagation of the display light beam, a plurality of display light beams are emitted from the transparent substrate. As a result, a display light beam is emitted from nearly the entire surface of the transparent substrate.

The display apparatus according to this disclosure holographically forms a display light beam. Therefore, high optical performance can be achieved with a display apparatus that is small and thin. Stating that the display light beam is formed holographically refers to forming (reproducing) the display light beam using a hologram.

In the display apparatus according to this disclosure, a plurality of display light beams are emitted from the transparent substrate as the display light beam is propagated. Therefore, the observer can view an image by looking at any one of the display light beams or at a plurality of the display light beams. In other words, the display light beams can be considered to be combined into one thick display light beam. Not only the axial display light beam displaying the center of an image, but also off-axis display light beams displaying edges of the image can be considered to be combined into one thick display light beam.

The display apparatus according to this disclosure thus emits a plurality of display light beams from the transparent substrate. This is equivalent to emitting one thick display light beam from the entire surface of the transparent substrate. Therefore, the entire surface of the transparent substrate is an exit pupil, and the size of the transparent substrate is the size of the exit pupil. Accordingly, the pupil is large, like a magnifying glass that itself is a pupil, allowing the observer to observe a virtual image easily without bringing the face close to the display apparatus.

In the display apparatus according to this disclosure, the display light beam emitted from the transparent substrate to the outside is a light beam displaying a virtual image at infinity. In other words, when the observer views display light beam, a virtual image is formed at infinity (far away). Therefore, when the observer looks at these display light beams, a virtual image is formed at infinity for each of the plurality of display light beams emitted from the transparent substrate. As a result, even if the observer is presbyopic and cannot focus on nearby objects, the observer can view a display in focus. Furthermore, the observer can view a virtual image formed at infinity no matter which display light beam the observer views, or even when viewing a plurality of display light beams simultaneously.

Next, the principle behind image display by the display apparatus according to this disclosure is described in greater detail with reference to the drawings.

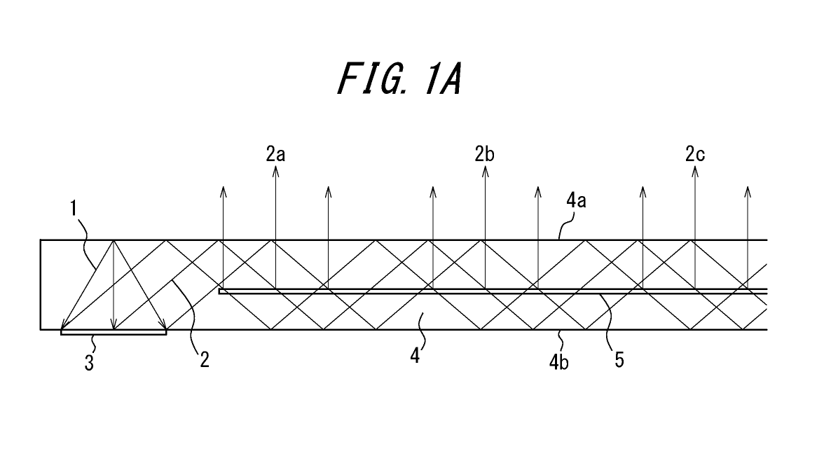

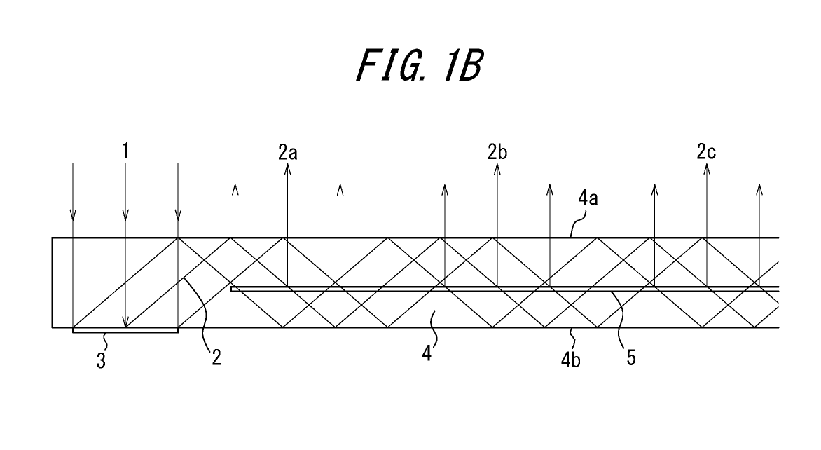

FIGS. 1A and 1B illustrate the principle behind image display by the display apparatus according to this disclosure. The display apparatus includes a Liquid Crystal On Silicon (LCOS) 3 that is a reflecting liquid crystal display element, a transparent substrate 4, and a diffraction grating 5. The LCOS 3 is a Spatial Phase Modulator (SPM) and is a hologram display element that holographically forms a display light beam 2.

The transparent substrate 4 includes an interface 4a and an interface 4b. In the transparent substrate 4 the display light beam 2 is reflected (total reflection) at the inner surfaces, i.e. at the interface 4a and the interface 4b. As a result, the display light beam 2 propagates through the inside of the transparent substrate 4.

The diffraction grating 5 constitutes a bifurcation. Each time the display light beam 2 undergoes internal reflection, the diffraction grating 5 emits a portion of the light beam to the outside of the transparent substrate 4. The diffraction grating 5 is positioned between the interface 4a and the interface 4b. The diffraction grating 5 may also be constituted by a volume hologram.

In order to form the display light beam an illumination light beam 1 needs to be incident on the LCOS 3. In FIGS. 1A and 1B, to simplify explanation, the illumination light beam 1 passes through the transparent substrate 4 from the interface 4a side of the transparent substrate 4 and is incident on the LCOS 3 disposed on the interface 4b side. FIG. 1A illustrates the case of the illumination light beam 1 from a light source (not illustrated) being a diverging light beam, and FIG. 1B illustrates the case of the illumination light beam 1 being a parallel light beam.

In FIGS. 1A and 1B, the illumination light beam 1 enters from the interface 4a and is incident on the LCOS 3 disposed at the interface 4b side. A phase hologram (hologram pattern, or phase pattern) is displayed on the LCOS 3. Therefore, the illumination light beam 1 incident on the LCOS 3 is diffracted by the phase hologram (LCOS 3). As a result, the display light beam 2 is generated holographically from the LCOS 3. The display light beam 2 is generated as first-order diffracted light (first-order light) of the hologram displayed on the LCOS 3. The zero-order diffracted light (zero-order light) regularly reflected by the LCOS 3 is emitted from the transparent substrate 4.

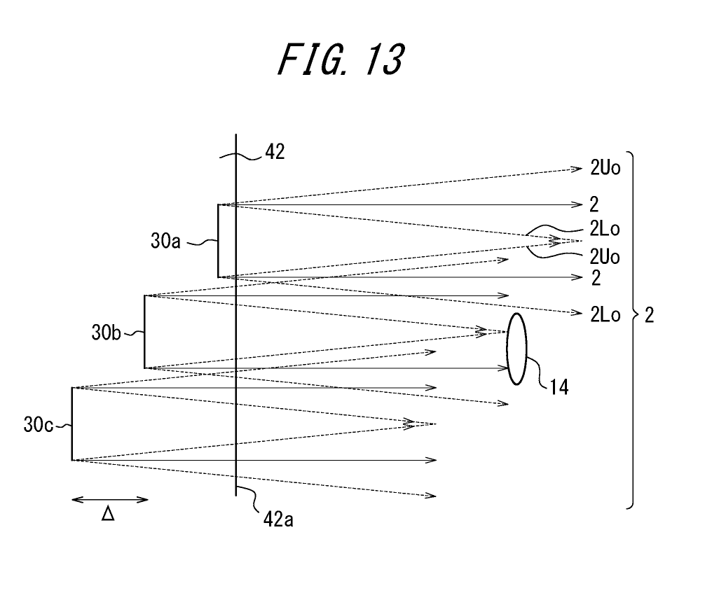

In the display apparatus in FIG. 1A, the phase hologram displayed on the LCOS 3 is a hologram that generates the parallel display light beam 2 when the illumination light beam 1 that is a diverging light beam is incident. On the other hand, in the display apparatus in FIG. 13, the phase hologram displayed on the LCOS 3 is a hologram that generates the parallel display light beam 2 when the parallel illumination light beam 1 is incident. In FIGS. 1A and 19, the display light beam 2 corresponds to an axial display light beam (a light beam exiting from the center of the image).

Other than the illumination light beam 1 that is a diverging light beam or a parallel light beam, an illumination light beam that is a convergent light beam may be caused to be incident on the LCOS 3. In the case of a convergent illumination light beam being incident on the LCOS 3, a hologram that generates a parallel display light beam when a convergent light beam is incident may be displayed on the LCOS 3. In FIGS. 1A and 1B, off-axis display light beams (light beams exiting from positions other than the center of the image) are also generated holographically from the LCOS 3, but for the sake of clarity, the off-axis display light beams are omitted from the drawing.

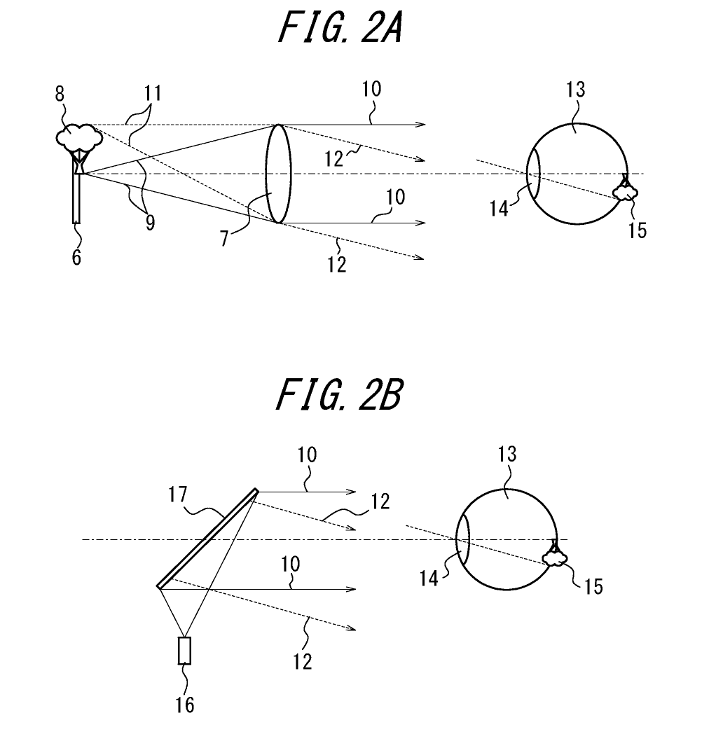

A method and apparatus for holographically displaying the display light beam 2 are now described with reference to FIGS. 2A and 2B. FIG. 2A is a diagram illustrating a regular optical system when observing a virtual image. FIG. 2B is a diagram illustrating an optical system that holographically forms a display light beam. The display light beam is a light beam for observing a virtual image (the parallel light beams 10, 12 in FIG. 2A).

The optical system illustrated in FIG. 2A is configured with a display element 6, such as an LCD, and a lens 7. By disposing the display element 6 at the focal position (front focal position) of the lens 7, the image 8 displayed on the display element 6 is projected to infinity by the lens 7. Here, the solid lines 9 are a light beam emitted from the center (axis) of the display element 6, and the dashed lines 11 are a light beam emitted from an edge (off-axis) of the display element 6. The light beam indicated by the solid lines 9 becomes a parallel light beam 10 and is emitted by the lens 7. The light beam indicated by the dashed lines 11 also becomes a parallel light beam 12 and is emitted by the lens 7.

The parallel light beams 10 and 12 are incident on the pupil 14 of the observer's eye 13. In this way, the observer can see a retina image 15 of the image 8. Since the light beams 10 and 12 incident on the observer's pupil 14 are parallel light beams, the observer observes a virtual image behind the display apparatus (in FIG. 2A, further to the left than the display element 6), i.e. at infinity. Accordingly, even if the observer is presbyopic and can only focus on distant objects, the observer can view the image 8 in focus.

FIG. 2B illustrates an optical system when the parallel light beams 10 and 12 are formed holographically. This optical system is configured with a coherent light source 16 and an SPM 17. A laser diode (LD), for example, may be used as the coherent light source 16. As the SPM 17, for example the above-described LCOS may be used. The SPM 17 is a hologram display element. In this disclosure, the hologram display element is also referred to as an SPM.

The hologram has a hologram pattern. The hologram pattern is an interference pattern formed by two wavefronts. One of the wavefronts is a wavefront emitted from the lens 7 in FIG. 2A, and the other wavefront is a wavefront emitted from the coherent light source 16 in FIG. 2B. Here, the wavefront emitted from the lens 7 (parallel light beams 10, 12) includes image information on the image 8. On the other hand, the wavefront emitted from the coherent light source 16 is a wavefront that generates an interference pattern, and at the same time, is a wavefront for generating reproduced light from the hologram.

The light emitted from the display element 6 is incoherent light. Therefore, no interference occurs even if the light emitted from the display element 6 is overlapped with the wavefront emitted from the coherent light source 16. In other words, a hologram pattern cannot be obtained. Therefore, in practice, a hologram (hologram pattern) is obtained by calculation. The calculated hologram is then displayed on the SPM 17 and illuminated with a coherent illumination light beam from the coherent light source 16. Parallel light beams 10 and 12 can be generated from the hologram with this approach. Between the parallel light beams 10 and 12, the parallel light beam 10 is the display light beam 2 illustrated in FIGS. 1A and 1B.

By viewing the parallel light beams 10 and 12 formed holographically, the observer can observe the image 8. In other words, the parallel light beams 10 and 12 are incident on the pupil 14 of the observer's eye 13 and form the retina image 15.

In the optical system illustrated in FIG. 2A, the lens 7 also needs to project an off-axis image (the image displayed at the periphery of the display element 6) onto the eye 13 with good resolving power. Therefore, in practice, the lens 7 is formed by a plurality of lenses. The diameter of the lens 7 also needs to be increased. For these reasons, when using the optical system illustrated in FIG. 2A in a display apparatus, it is difficult to make the display apparatus thinner and smaller.

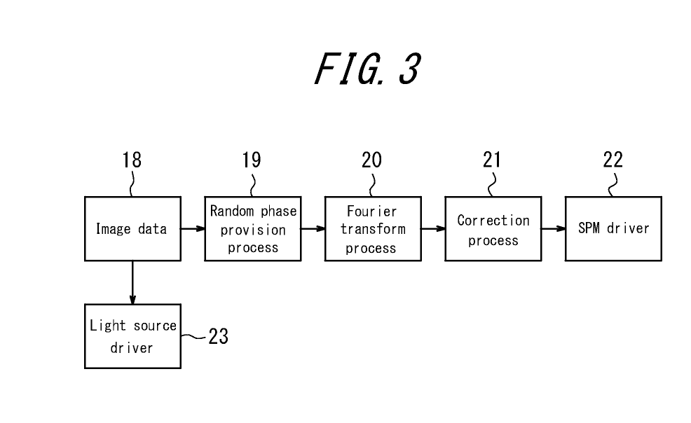

Next, a method for obtaining the hologram by calculation is described. FIG. 3 is a block diagram illustrating processing when obtaining a hologram by calculation. As illustrated in FIG. 3, image data 18 is first prepared. The image data 18 is the data that is input into the display element 6 in FIG. 2A. The wavefront emitted from the lens 7 is obtained by performing a Fourier transform on the image data 18 with a Fourier transform process 20.

Along with a spatial phase distribution, a spatial intensity distribution also occurs in the spatial frequency distribution obtained by the Fourier transform. Therefore, a phase hologram with a high diffraction efficiency cannot be formed. To address this issue, a random phase provision process 19 is performed before the Fourier transform process 20. By providing (weighting) the image data 18 with random phase information, the value of the spatial intensity after the Fourier transform can be made uniform across the entire spatial frequency plane, i.e. the spatial intensity can be made nearly even. As a result, the hologram can be made into a phase hologram having only phase information.

Next, a correction process 21 is performed. The correction process 21 is a correction process based on the arrangement of the optical system. For example, in the optical system illustrated in FIG. 2B, parallel light beams 10 and 12 are generated by a wavefront from the coherent light source 16. In this case, an accurate display light beam 2 (parallel light beams 10 and 12) needs to be formed. Since the wavefront from the coherent light source 16 is a spherical wave, the hologram is calculated with the information of this spherical wave during the correction process 21. Subsequently, the calculation results (hologram information) is input into an SPM driver 22. With control information from the SPM driver 22, a hologram is displayed on the SPM 17 (the LCOS 3 in FIGS. 1A and 1B).

Since the diffraction efficiency of the SPM 17 is nearly constant, the brightness ends up being approximately the same for both an image of a bright scene and an image of a dark scene. Accordingly, when forming the display light beam holographically, the amount of light caused to be incident on the SPM 17 needs to be controlled in accordance with the total amount of light in the image. Therefore, the brightness of the light source is controlled by inputting data on the total amount of light of the image data 18 into a light source driver 23.

This explanation now returns to FIG. 1A. The display light beam 2 emitted from the LCOS 3 is totally reflected at the interface 4a of the transparent substrate 4 and is incident on the diffraction grating 5. At the diffraction grating 5, a portion of the display light beam 2 is diffracted. The direction of diffraction is the normal direction to the interface 4a. The light beam diffracted at the diffraction grating 5 is emitted from the transparent substrate 4 to the outside and becomes a display light beam 2a.

The display light beam 2 passing through the diffraction grating 5 is further totally reflected at the interface 4b of the transparent substrate 4 and passes through the diffraction grating 5. The display light beam 2 passing through the diffraction grating 5 is once again totally reflected at the interface 4a and is incident on the diffraction grating 5. At the diffraction grating 5, a portion of the display light beam 2 is diffracted. The direction of diffraction is the normal direction to the interface 4a. The light beam diffracted at the diffraction grating 5 is emitted from the transparent substrate 4 to the outside and becomes a display light beam 2b. Similarly, the display light beam 2 propagates inside the transparent substrate 4 and forms a new display light beam 2c. By such repetition, multiple display light beams 2a, 2b, 2c, . . . are emitted from the entire surface of the transparent substrate 4 (interface 4a).

By at least one of the display light beams 2a, 2b, 2c, . . . entering the observer's eye, the observer can observe a virtual image. For example, when the image data 18 is a movie, the observer can watch the movie. When the image data 18 is a still image, the observer can view the still image.

In FIG. 1A, the display light beam 2 is formed using the LCOS 3. Therefore, a display apparatus that is small and thin while having high optical performance can be achieved. The light beam incident on the LCOS 3 may be restricted to being an axial light beam. Therefore, the light emitted from the light source may be used as is as the light beam incident on the LCOS 3. In this case, a lens for light beam conversion becomes unnecessary, allowing a reduction in thickness and size of the display apparatus.

As illustrated in FIG. 1B, even in the case of the illumination light beam 1 incident on the LCOS 3 being a parallel light beam, it suffices for only a parallel axial light beam to be incident on the LCOS 3. Therefore, a lens for converting a convergent light beam or a diverging light beam into a parallel light beam can be simplified. Hence, even in the case of the illumination light beam 1 incident on the LCOS 3 being a parallel light beam, the display apparatus can be reduced in thickness and size. The display apparatus can similarly be reduced in thickness and size also in the case of a convergent light beam being incident on the LCOS 3.

In the display apparatus illustrated in FIGS. 1A and 1B, the display light beam 2 is formed holographically at the LCOS 3. Therefore, as described above, the display apparatus can be reduced in thickness and size.

In the display apparatus illustrated in FIGS. 1A and 1B, as the display light beam is propagated, a plurality of display light beams 2a, 2b, 2c, . . . are emitted from the transparent substrate 4. By at least one of the display light beams entering the pupil of the eye, the observer can observe a virtual image. In this way, a plurality of display light beams 2a, 2b, 2c, . . . exist in the transparent substrate 4, which is equivalent to an increase in the diameter of the display light beam. Display light beams include an axial light beam that displays the center of the image and off-axis light beams that display edges of the image, but these display light beams become thicker, and the exit pupil becomes the entire surface of the transparent substrate 4 from which the display light beams are emitted. Therefore, the allowable range for aligning the eye with the display light beam (transparent substrate 4) is wider than when the diameter of the display light beam is small (thin). As a result, the observer can easily observe the virtual image.

As described above, an LCOS is used in the SPM, but a deformable mirror may also be used. The deformable mirror may be composed of a plurality of minute mirrors each of which may be moved to deflect light or composed of one thin deformable mirror.

The display apparatus may, for example, be manufactured as follows. First, a recess is formed on a portion of the transparent substrate 4, specifically the portion where the diffraction grating 5 is to be provided. The diffraction grating 5 is then disposed in this recess. Subsequently, the diffraction grating 5 is covered from above with a transparent member approximately matching the recess. Alternatively, a slit-shaped recess parallel to the interface 4a may first be formed on the side of the transparent substrate 4. The diffraction grating 5 is then inserted into this recess. Subsequently, the side is covered with a transparent member, adhesive, or the like.

In the structure illustrated in FIGS. 1A and 1B, the zero-order regular reflection light of the hologram displayed on the SPM formed by the LCOS 3 needs to be emitted reliably from the interface 4a so as not to enter into the first-order display light beam 2. To this end, the display light beam 2 needs to have a large diffraction angle.

A hologram is one type of diffraction grating. Accordingly, the grating equation d=mλ/(sin θS−sin θI) holds, where d is the pitch of the diffraction grating, θI is the angle of incidence, θS is the angle of diffraction, m is the diffraction order, and λ is the wavelength.

The SPM has a structure in which minute pixels are arranged in one dimension or two dimensions, and the SPM displays a hologram using the minute pixels. Accordingly, the size of two minute pixels, i.e. two times the pixel pitch corresponds to the pitch d of the diffraction grating.

As is clear from the aforementioned grating equation, by setting the angle of incidence θI to be constant, the angle of diffraction θS decreases as the pitch d of the diffraction grating increases, i.e. as the pixel pitch of the SPM increases. Since the angle of reflection of zero-order light is the same angle as the angle of incidence θI, it becomes difficult to separate zero-order light from first-order light as the angle of diffraction θS is smaller.

Therefore, in a preferred embodiment of the display apparatus according to this disclosure, separation of reflected light and diffracted light is made easy even when the angle of diffraction at the SPM is small.

### Embodiment 1

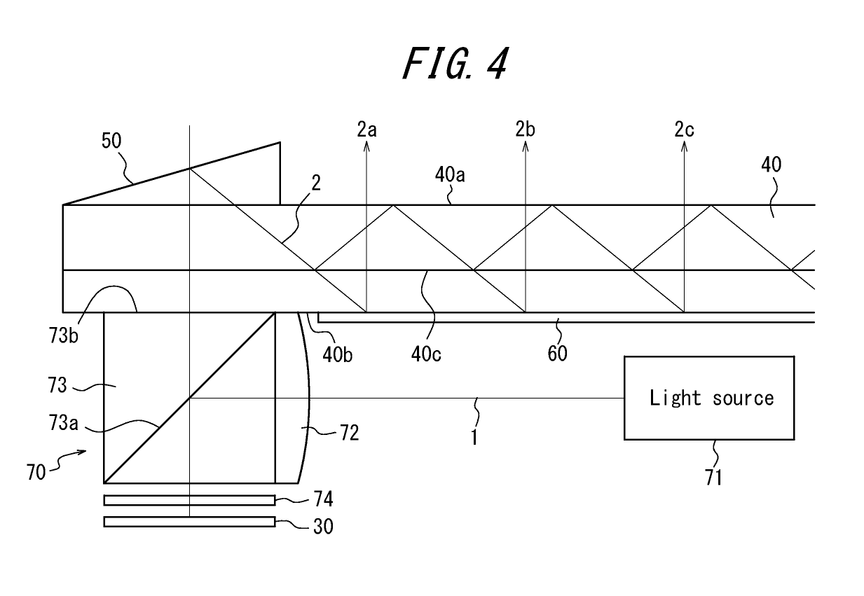

FIG. 4 schematically illustrates the structure of a display apparatus according to Embodiment 1. The display apparatus illustrated in FIG. 4 includes a LCOS (a reflecting liquid crystal display element) 30, a transparent substrate 40, a reflecting prism 50, a prism array 60, and a light beam introduction optical system 70. The light beam introduction optical system 70 is provided with a light source 71, a lens 72, a polarizing beam splitter 73, and a quarter-wavelength plate 74.

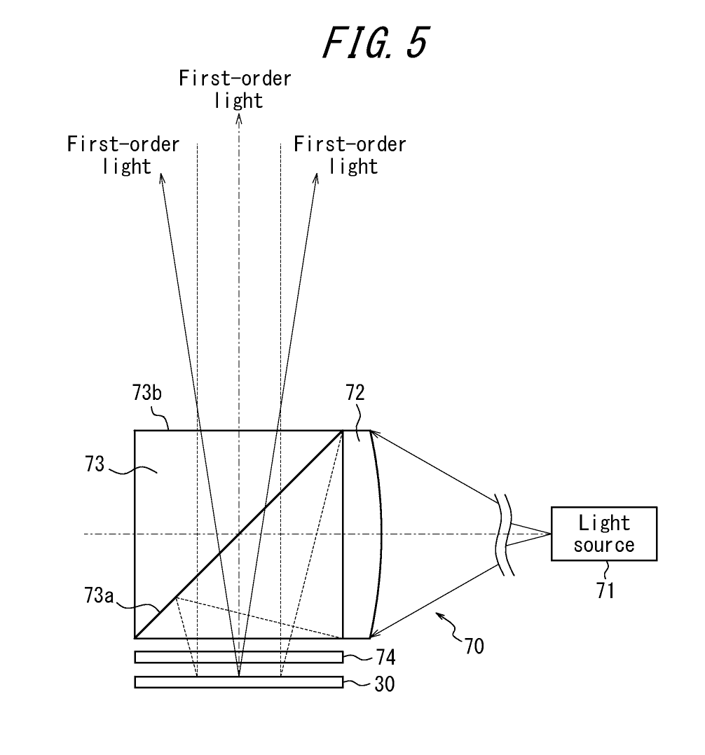

A semiconductor laser, for example, is used as the light source 71, and an illumination light beam 1 is emitted in a direction parallel to the transparent substrate 40. As illustrated in the partial detail drawing in FIG. 5, the illumination light beam 1 emitted from the light source 71 passes through the lens 72 and is incident on the polarizing beam splitter 73, for example as s-polarized light. The illumination light beam 1 incident on the polarizing beam splitter 73 is reflected at a polarizing film 73a of the polarizing beam splitter 73 and is emitted from the polarizing beam splitter 73. The illumination light beam 1 emitted from the polarizing beam splitter 73 is converted to circularly-polarized light by passing through the quarter-wavelength plate 74 and irradiates the LCOS 30.

Like the above-described LCOS 3, the LCOS 30 is an SPM and is a hologram display element that holographically forms the display light beam. The LCOS 30 is disposed so that a normal thereto is nearly parallel to a central light ray of the illumination light beam 1 emitted from the light beam introduction optical system 70. As a result, the LCOS 30 is illuminated by the illumination light beam 1 from a nearly perpendicular direction.

The diffracted light reflected by the LCOS 30 due to irradiation by the illumination light beam 1 is converted again to linearly-polarized light by the quarter-wavelength plate 74 and is incident on the polarizing beam splitter 73 as p-polarized light. The diffracted light incident on the polarizing beam splitter 73 passes through the polarizing film 73a of the polarizing beam splitter 73 and is emitted from the polarizing beam splitter 73. The diffracted light emitted from the polarizing beam splitter 73 is incident on the transparent substrate 40.

Here, phase information corresponding to the above-described Fourier transform of the image information is displayed on the LCOS 30. Accordingly, the LCOS 30 corresponds to the pupil position in a regular image forming optical system, and the angle of view of the image becomes the angle of the light beam. The first-order diffracted light (first-order light) of the LCOS 30, including the angle information, is emitted from the pupil position as a display light beam. FIG. 4 illustrates a representative, parallel display light beam 2.

The transparent substrate 40 includes an interface 40a and an interface 40b that are parallel. A semi-transparent film 40c is formed between the interface 40a and the interface 40b. Such a transparent substrate 40 may, for example, be configured by preparing two transparent, parallel flat plates, forming the semi-transparent film 40c on the surface of one of the transparent, parallel flat plates, and joining the other transparent, parallel flat plate onto the top of the semi-transparent film 40c.

The polarizing beam splitter 73 is disposed so that an exit surface 73b for diffracted light opposes or is joined to the interface 40b at one end of the transparent substrate 40. The reflecting prism 50 is joined to the interface 40a opposing the polarizing beam splitter 73 or is formed integrally with a substrate that forms the interface 40a. The prism array 60 is joined to the interface 40b or formed integrally with a substrate that forms the interface 40b.

The diffracted light incident on the transparent substrate 40 from the polarizing beam splitter 73 passes through the transparent substrate 40 and is incident on the reflecting prism 50. The reflecting prism 50 is joined to the transparent substrate 40 so as to reflect, among the incident diffracted light, first-order light to be incident on the transparent substrate 40 and so as to transmit other diffracted light, including zero-order light, or reflect the light in another direction.

The first-order light reflected by the reflecting prism 50 is incident on the transparent substrate 40 as a display light beam 2. The display light beam 2 incident on the transparent substrate 40 is propagated towards the other end of the transparent substrate 40 while being repeatedly reflected between the interface 40a and the semi-transparent film 40c. In other words, the display light beam 2 undergoes amplitude division at the semi-transparent film 40c into reflected light and transmitted light and is totally reflected at the interface 40a.

The display light beam 2 transmitted by the semi-transparent film 40c is incident on the prism array 60. The prism array 60 constitutes a bifurcation. So that the incident display light beam 2 is emitted from the interface 40a, the prism array 60 reflects the display light beam 2 in the direction of the interface 40a, causing the display light beam 2 to pass through the semi-transparent film 40c and be emitted from the interface 40a as display light beams 2a, 2b, 2c, . . . . Off-axis display light beams (light beams exiting from positions other than the center of the image) are also generated holographically from the LCOS 30, but for the sake of clarity, the off-axis display light beams are omitted from the drawing. Furthermore, only central light rays within the axial light beam are illustrated for the display light beam 2. The drawings are also the same with respect to these points in the other embodiments described below.

According to the display apparatus of this embodiment, in the light beam introduction optical system 70, an illumination light beam 1 emitted from the light source 71 in a direction nearly parallel to the transparent substrate 40 is caused to be incident on the LCOS 30 in a nearly perpendicular direction using the polarizing beam splitter 73. The diffracted light from the LCOS 30 is caused to pass through the polarizing beam splitter 73 and the transparent substrate 40 and be incident on the reflecting prism 50, and due to the reflecting prism 50, the display light beam 2 that is first-order light is reflected to be incident on the transparent substrate 40. Accordingly, even if the angle of diffraction of the first-order light of the LCOS 30 is small, the first-order light can be reliably separated from zero-order light or diffracted light of a different order by the reflecting prism 50.

The optical path of the diffracted light between the LCOS 30 and the transparent substrate 40 is powerless, i.e. the lens power in the optical path of the diffracted light is zero. As a result, a display apparatus that is small and thin while having high optical performance can be achieved. Using the polarizing beam splitter 73 and the quarter-wavelength plate 74, the illumination light beam 1 and the diffracted light of the LCOS 30 undergo a polarization split, thereby also increasing the usage efficiency of light. In FIG. 4, the orientation of the polarizing beam splitter 73 may be rotated so that the lens 72 is behind the paper, and the light source 71 may be disposed behind the paper.

### Embodiment 2

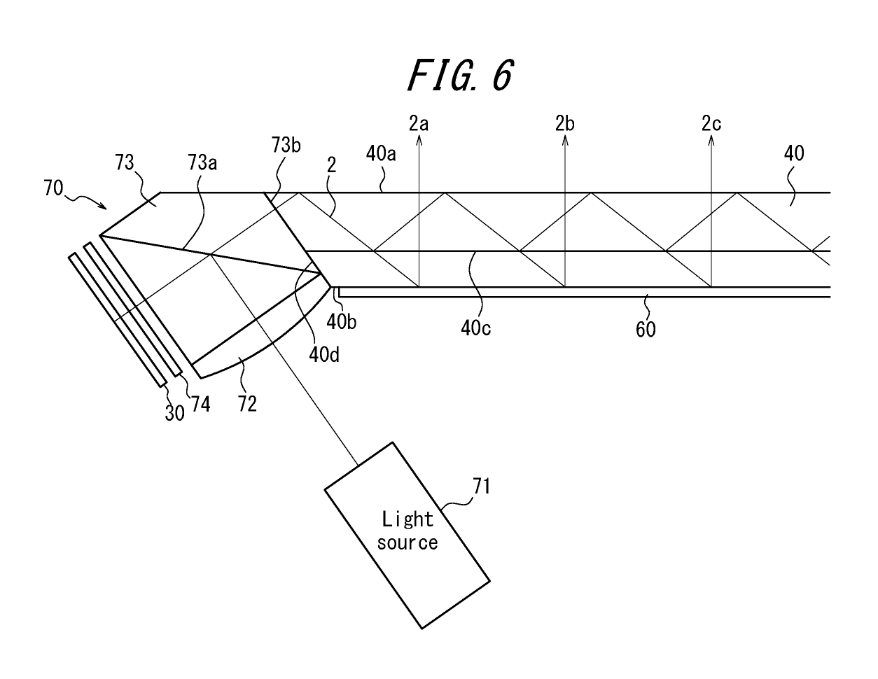

FIG. 6 schematically illustrates the structure of a display apparatus according to Embodiment 2. The display apparatus illustrated in FIG. 6 has the structure of the display apparatus illustrated in FIG. 4, except that among the diffracted light from the LCOS 30 emitted from the polarizing beam splitter 73, the display light beam 2 that is first-order light is caused to be incident on the interface 40a from one end 40d of the transparent substrate 40 under a condition of total reflection.

Therefore, the end 40d is formed to be inclined relative to the interfaces 40a and 40b, and the exit surface 73b of the polarizing beam splitter 73 opposes or is joined to the inclined end 40d. The diffracted light from the LCOS 30 emitted from the exit surface 73b of the polarizing beam splitter 73 is incident on the inclined end 40d of the transparent substrate 40, and the display light beam 2 that is first-order light is totally reflected at the interface 40a. The display light beam 2 that is totally reflected at the interface 40a propagates through the transparent substrate 40 as in Embodiment 1 and is emitted from the interface 40a as display light beams 2a, 2b, 2c, . . . . Members having the same function as in FIG. 4 are labeled with the same reference signs, and a description thereof is omitted.

Accordingly, the same effects as in Embodiment 1 can be achieved in this embodiment as well. In this embodiment, the reflecting prism 50 in FIG. 4 is unnecessary. Hence, the number of components can be reduced, which lowers costs. The polarizing beam splitter 73 is cut to have the same planar surface as the interface 40a of the transparent substrate 40, thus allowing a further reduction in thickness. In FIG. 6, along with the exit surface 73b of the polarizing beam splitter 73 being inclined relative to the interface 40a of the transparent substrate 40, the illumination light beam 1 from the light source 71 is inclined relative to the transparent substrate 40 and caused to be incident on the polarizing beam splitter 73. The illumination light beam 1 may, however, be emitted from the light source 71 in a direction parallel to the transparent substrate 40, and a reflecting member or the like may suitably be used to cause the illumination light beam 1 to be incident on the polarizing beam splitter 73. This approach allows a further decrease in thickness.

### Embodiment 3

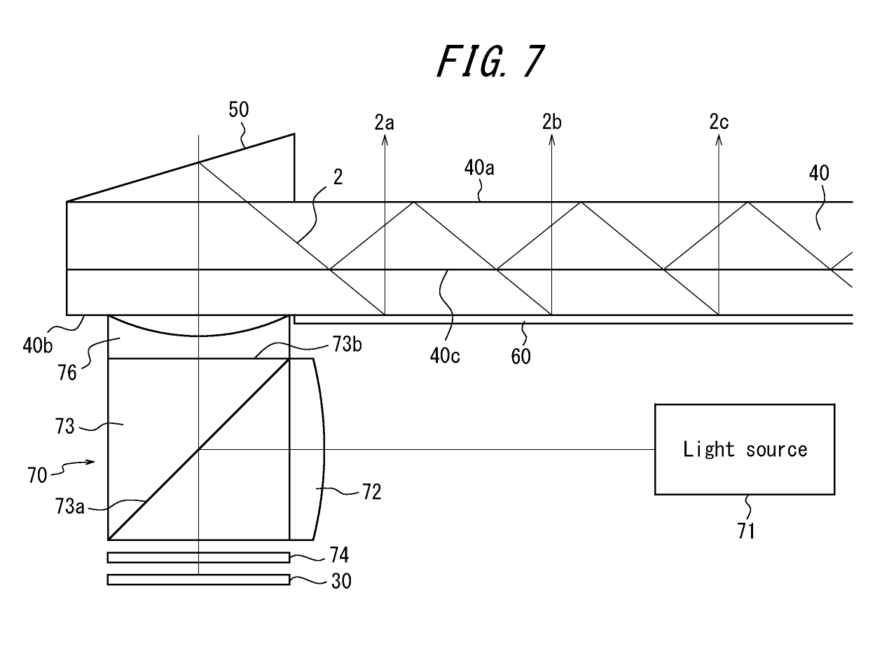

FIG. 7 schematically illustrates the structure of a display apparatus according to Embodiment 3. The display apparatus illustrated in FIG. 7 has the structure of the display apparatus illustrated in FIG. 4, except that a concave lens 76 with a negative lens power is disposed in the optical path of the diffracted light between the polarizing beam splitter 73 and the transparent substrate 40. In other words, the lens power in the optical path of the display light beam between the SPM and the transparent substrate is negative. Since the remaining structure is similar to that of FIG. 4, members having the same function as in FIG. 4 are labeled with the same reference signs, and a description thereof is omitted.

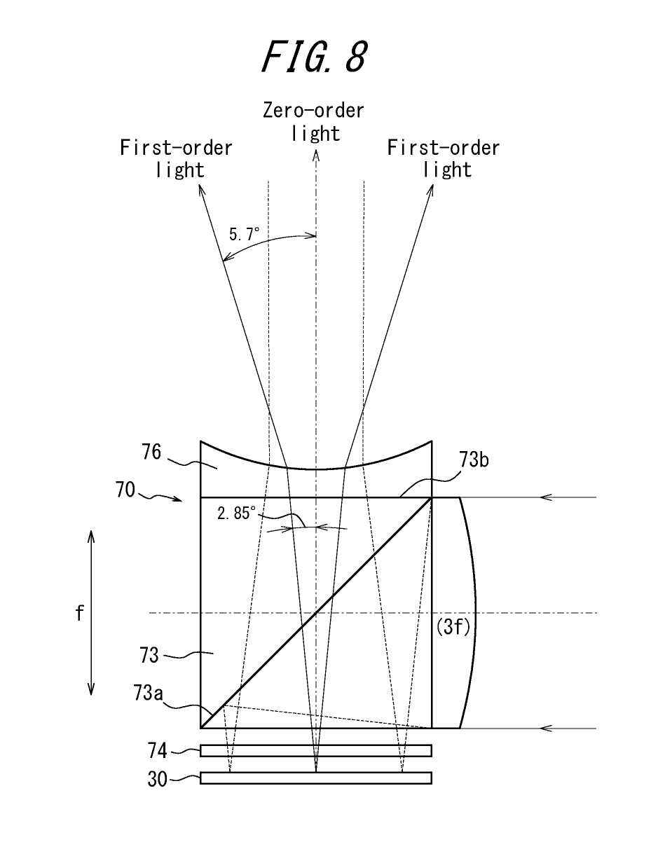

In this way, by disposing the concave lens 76 at the exit surface 73b side of the polarizing beam splitter 73 from which the diffracted light of the LCOS 30 is emitted, the angle of view of the image displayed by the display light beam can be expanded. For example, in FIG. 7, the pixel pitch d of the LCOS 30 is 11 μm, and the wavelength λ of the illumination light beam 1 is 0.55 μm. In this case, as illustrated in the partial detail drawing in FIG. 8, the angle of diffraction θ of the first-order light is approximately 2.85°, since d sin θ=λ. In other words, the angle of view due to first-order light is ±2.85°.

As illustrated in FIG. 8, the angle of deflection is approximately doubled by disposing the LCOS 30 at the focal position, where the focal length of the concave lens 76 is −f. As a result, using the same LCOS 30 and an illumination light beam 1 with the same wavelength, an angle of view of ±5.7° can be guaranteed. This angle of view corresponds to a pixel pitch of the LCOS 30 of ½, i.e. approximately 5.5 μm.

In this case, in the direction of an angle of view of ±5.7°, first-order light including image information (extent of the angle of view) over a range of ±5.7° to the left and right of zero-order light is generated, but in a direction perpendicular to the direction of the angle of view of ±5.7°, the zero-order light is cut closely by the condition for total reflection of first-order light by the reflecting prism 50. Furthermore, in order to turn the diffracted light emitted from the concave lens 76 into parallel light, the lens 72 is formed by a convex lens with a focal length of 3f. The illumination light beam 1 from the light source 71 is caused to be incident on the lens 72 as a parallel light beam, and an illumination light beam 1 that is convergent light is caused to be incident on the LCOS 30.

Therefore, according to this embodiment, the pupil position (virtual image of the LCOS 30) can be brought closer to the entrance pupil of the transparent substrate 40, in addition to the effects of the above-described embodiment. In FIG. 7, the orientation of the polarizing beam splitter 73 may be rotated so that the lens 72 is behind the paper, and the light source 71 may be disposed behind the paper.

### Embodiment 4

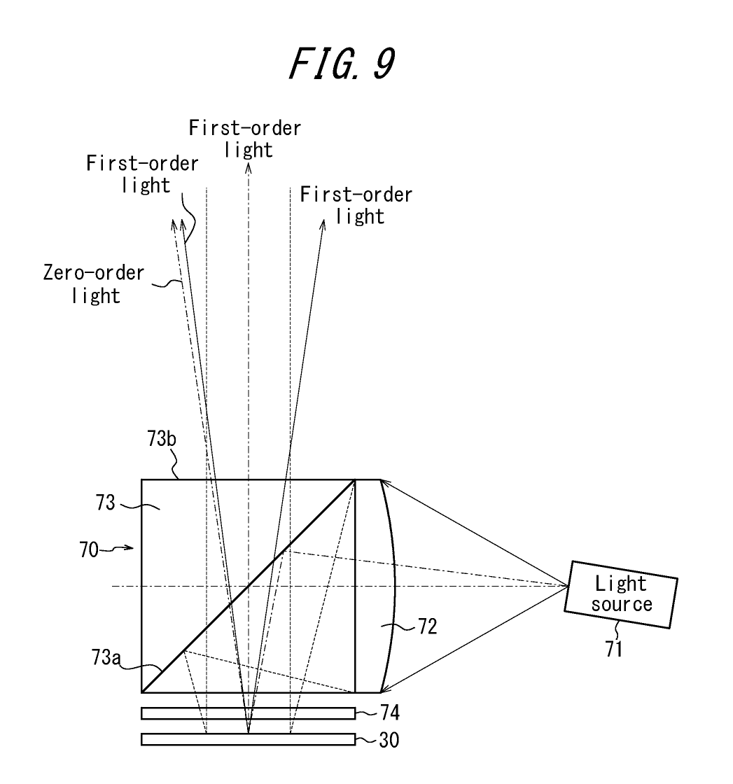

FIG. 9 schematically illustrates the main structure of a display apparatus according to Embodiment 4. The display apparatus of this embodiment has the structure of the display apparatus illustrated in FIG. 4, except that the light source 71 constituting part of the light beam introduction optical system 70 is disposed at an inclination relative to the optical axis of the lens 72, and the illumination light beam 1 from the light source 71 is caused to be incident on the LCOS 30 so that the central light ray thereof is inclined relative to a normal to the LCOS 30. The remaining structure is similar to that of FIG. 4.

In this embodiment, the zero-order light is, for example, removed by the reflecting prism 50 (see FIG. 4) in a direction in which the angle of view is small. At this time, in the direction in which the angle of view is small, image information (angle of view) is included in the first-order light on one side of the zero-order light. In the direction in which the angle of view is small, the angle of reflection of zero-order light at the LCOS 30 becomes larger than the half angle of view in that direction.

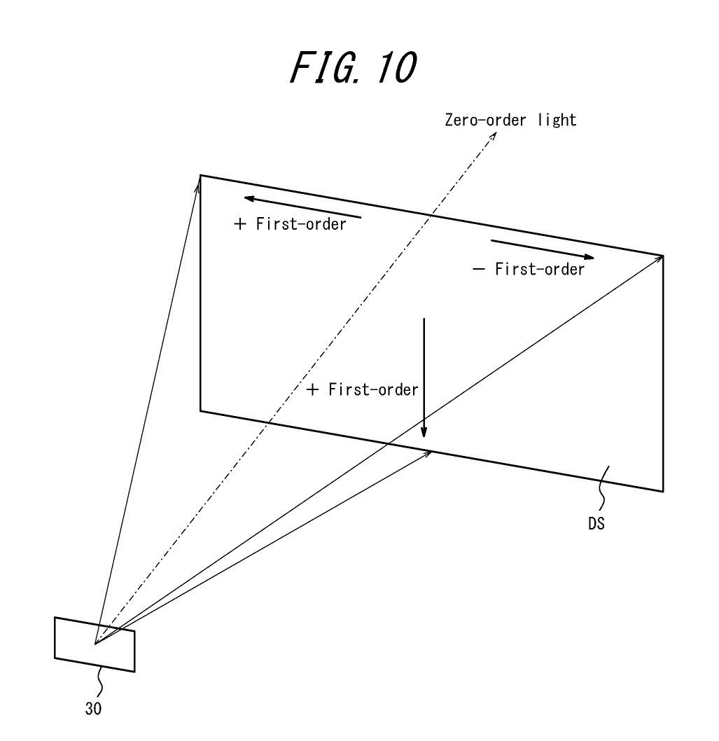

As a result, for example as schematically illustrated in FIG. 10, a display area DS can be formed to have a wide angle of view due to first-order light to the left and right of zero-order light (±first-order diffracted light), and in a direction perpendicular to the direction of this angle of view, to have a narrow angle of view due to first-order light on one side where the zero-order light is cut closely (for example, +first-order diffracted light). Accordingly, for example High-Definition (HD) display with an aspect ratio of 16:9 can easily be supported.

### Embodiment 5

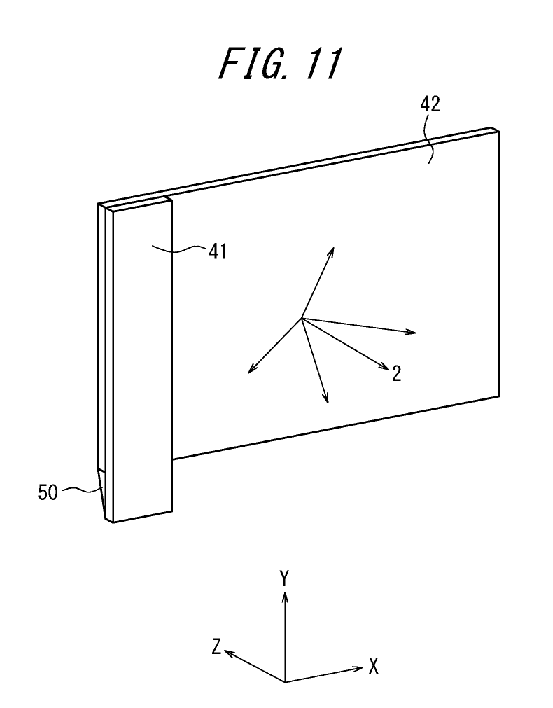

FIG. 11 schematically illustrates the structure of a display apparatus according to Embodiment 5. The display apparatus according to this embodiment includes a first transparent substrate 41 and a second transparent substrate 42. The first transparent substrate 41 is positioned at an end of the second transparent substrate 42 and is fixed to the second transparent substrate 42 at this position.

The first transparent substrate 41 is configured in the same way as the transparent substrate 40 described in Embodiment 1, and diffracted light from a light beam introduction optical system 70 (not illustrated) is incident thereon. The first transparent substrate 41 includes a reflecting prism 50 for separating zero-order light and first-order light (display light beam) from the incident diffracted light and a prism array 60 (not illustrated) for emitting, from the first transparent substrate 41, the propagated display light beam.

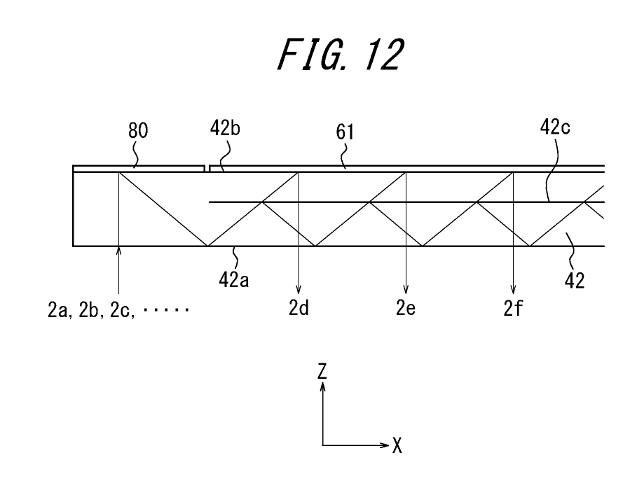

As illustrated in FIG. 12, like the first transparent substrate 41, the second transparent substrate 42 includes an interface 42a and an interface 42b that are parallel. A semi-transparent film 42c is formed between the interface 42a and the interface 42b. Such a second transparent substrate 42 may, for example, be configured by preparing two transparent, parallel flat plates, forming the semi-transparent film 42c on the surface of one of the transparent, parallel flat plates, and joining the other transparent, parallel flat plate onto top of the semi-transparent film 42c.

The first transparent substrate 41 is fixed onto the interface 42a side at one end of the second transparent substrate 42. At the interface 42b side, the second transparent substrate 42 includes a prism array 80 in an area opposing the first transparent substrate 41 and includes a prism array 61 in other area of the interface 42b. Like the prism array 60 on the first transparent substrate 41 side, the prism array 61 is joined to the interface 42b or formed integrally with a substrate that forms the interface 42b.

This structure is now described in detail. As illustrated in FIG. 11, the first transparent substrate 41 is configured to be rectangular and is disposed with the long sides along the y-axis direction. As described with reference to FIG. 4, the first transparent substrate 41 propagates the display light beam 2 in the direction of the long sides while emitting display light beams 2a, 2b, 2c, . . . from the first transparent substrate 41 in a perpendicular direction (z-axis direction) to be incident on the second transparent substrate 42. The thickness of the first transparent substrate 41 is, for example, 2 mm to 4 mm.

As illustrated in FIG. 11, the second transparent substrate 42 is configured to be an approximately rectangular plate. The second transparent substrate 42 has the same length in the y-axis direction (short sides) as the length of the long sides of the first transparent substrate 41, excluding the reflecting prism 50. The length in the x-direction (long sides) is greater than the length of the short sides of the first transparent substrate 41. The shape of the second transparent substrate 42 is not limited to being rectangular. The second transparent substrate 42 propagates the incident display light beams 2a, 2b, 2c, . . . along the x-axis direction. The thickness of the second transparent substrate 42 is, fir example, 2 mm to 4 mm.

As illustrated in FIG. 12, the display light beams 2a, 2h, 2c, . . . incident on the second transparent substrate 42 are deflected by the prism array 80. The deflected display light beams 2a, 2b, 2c, . . . are propagated in the x-axis direction of the second transparent substrate 42 while repeatedly being reflected between the interface 42a and the semi-transparent film 42c of the second transparent substrate 42. In other words, the display light beams 2a, 2b, 2c, . . . undergo amplitude division at the semi-transparent film 42c into reflected light and transmitted light and are totally reflected at the interface 42a.

The display light beam transmitted by the semi-transparent film 42c is incident on the prism array 61. The prism array 61 constitutes a second bifurcation. So that the incident display light beams are emitted from the interface 42a, the prism array 61 reflects the display light beams in the z-axis direction, causing the display light beams to pass through the semi-transparent film 42c and be emitted from the interface 42a as display light beams 2d, 2e, 2f, . . . .

In this way, the display light beam 2a repeatedly undergoes total reflection inside the second transparent substrate 42 and propagates in the x-axis direction inside the second transparent substrate 42. While propagating, display light beams 2d, 2e, 2f, . . . are emitted one after another in the z-axis direction from the second transparent substrate 42. The same is true for the display light beams 2b and 2c. In other words, as illustrated in FIG. 11, the display light beam 2 expands in the y-axis direction of the display apparatus while propagating inside the first transparent substrate 41 and then expands in the x-axis direction of the display apparatus while propagating inside the second transparent substrate 42. As a result, the display light beam 2 is emitted from the entire surface (interface 42a) of the display apparatus.

The light beam emitted from the display apparatus according to this embodiment is now described. FIG. 13 illustrates the optical distance of light beams emitted from the display apparatus. As illustrated in FIG. 11, the display light beam 2 is emitted from the surface (interface 42a) of the second transparent substrate 42 of the display apparatus. As illustrated in FIG. 12, this display light beam 2 is formed by display light beams 2d, 2e, 2f, . . . . When an observer views such a display apparatus, a portion of the display light beam enters the pupil 14 of the observer's eye. The observer can thus see the display (virtual image).

In FIG. 13, the display light beam is shown being emitted from three positions 30a, 30b, and 30c. Each of the three display light beams is constituted by a display light beam 2, a most off-axis display light beam 2Uo, and a most off-axis display light beam 2Lo. The display light beam 2 corresponds to a light beam emitted along the axis (from the center of the image). The most off-axis display light beam 2Uo corresponds to a light beam emitted farthest off the axis (from one edge of the image). The most off-axis display light beam 2Lo corresponds to a light beam emitted farthest off the axis (from the other edge of the image).

The positions 30a, 30b, and 30c are respective optical positions of the LCOS 30 (see FIG. 4) when viewed from the observer's side. These optical positions are the distance from the surface (interface 42a) of the second transparent substrate 42 to the LCOS 30.

The position 30a is the optical position of the LCOS 30 when the display light beam 2 is totally reflected only once in the second transparent substrate 42 and emitted. The position 30b is the optical position of the LCOS 30 when the display light beam 2 is totally reflected twice in the second transparent substrate 42 and emitted. The position 30c is the optical position of the LCOS 30 when the display light beam 2 is totally reflected three times in the second transparent substrate 42 and emitted.

The difference Δ in the optical distance between two optical positions is the distance of propagation due to one total reflection in the second transparent substrate 42. In greater detail, this distance is the distance over which the display light beam 2 travels from the semi-transparent film 42c to the interface 42a and back.

Three optical positions 30a, 30b, and 30c are illustrated in FIG. 13, but the number of optical positions of the LCOS 30 actually equals the number of light beams that propagate in two dimensions by repeatedly being totally reflected. Display light beams 2 from the LCOS 30 at a plurality of different optical positions are normally incident on the observer's pupil 14.

In the LCOS 30, the display light beam 2, the most off-axis display light beam 2Lo, and the most off-axis display light beam 2Uo are formed holographically by coherent light. Therefore, the display light beam 2, the most off-axis display light beam 2Lo, and the most off-axis display light beam 2Uo are each coherent light. As illustrated in FIG. 13, when the observer's pupil 14 is directly facing the position 30b, the display light beams (2, 2Lo, 2Uo) from the position 30b are mainly incident on the pupil 14, but depending on the position of the pupil 14, display light beams from the position 30a or the position 30c may also be incident.

As described above, the display light beams from the position 30a, the display light beams from the position 30b, and the display light beams from the position 30c are each coherent light. Therefore, for example when a display light beam from the position 30b and a display light beam from the position 30a are incident on the observer's pupil 14, the two light beams interfere with each other, and it is assumed that the observed virtual image will end up becoming an unintended image (virtual image). An unintended image is, for example, an image with degraded image quality.

Therefore, the coherence length of the illumination light beam 1 emitted from the light source 71 (see FIG. 4), i.e. the coherence length of the display light beam 2, is preferably shorter than the difference Δ in the optical distance. In other words, the coherence length of the display light beam 2 is preferably shorter than the distance of propagation due to one total reflection in the second transparent substrate 42. With this configuration, formation of an unintended image can be prevented even when a plurality of display light beams with different optical distances are incident on the observer's eye.

In the display apparatus according to this embodiment, as the display light beam is propagated, a plurality of display light beams 2d, 2e, 2f, . . . are emitted from the second transparent substrate 42. Therefore, the observer can view an image by looking at any one of the display light beams or at a plurality of the display light beams. In other words, the display light beams can be considered to be combined into one thick display light beam. Not only axial display light beam displaying the center of an image, but also off-axis display light beams displaying edges of the image can be considered to be combined into one thick display light beam.

In this way, in the display apparatus according to this embodiment, a plurality of display light beams are emitted from the surface of the display apparatus, which is equivalent to one thick display light beam being emitted from the entire surface of the display apparatus. Therefore, the entire surface of the display apparatus is an exit pupil, and the size of the surface of the display apparatus is the size of the exit pupil. Accordingly, the pupil is large, like a magnifying glass that itself is a pupil, allowing the observer to observe a virtual image easily without bringing the face close to the display apparatus.

The display light beams 2d, 2e, 2f, . . . (display light beam 2) emitted from the second transparent substrate 42 to the outside are light beams displaying a virtual image at infinity. In other words, when the observer views the display light beam, a virtual image is formed at infinity (far away). Therefore, when the observer looks at these display light beams, a virtual image is formed at infinity for each of the plurality of display light beams emitted from the second transparent substrate 42. As a result, even if the observer is presbyopic and cannot focus on nearby objects, the observer can view a display in focus. Furthermore, the observer can view a virtual image formed at infinity no matter which display light beam the observer views, or even when viewing a plurality of display light beams simultaneously. In Embodiments 2 to 4 as well, two transparent substrates may of course be used to configure the display apparatus to have two-dimensional expansion.

This disclosure is not limited to the above embodiments, and a variety of changes or modifications may be made. For example, in the above-described embodiments, an SPM is used to generate the display light beam holographically. The display light beam may, however, be generated holographically without using an SPM. For example, in the case of a still image, the hologram pattern does not need to be changed. Therefore, the hologram pattern may be recorded onto a film, and the film may be disposed at the position of the SPM. Apart from film, any material having the property of allowing a hologram pattern to be recorded only once may be used.

The transparent substrate 40 described in Embodiments 1 to 3 and the first transparent substrate 41 and second transparent substrate 42 described in Embodiment 5 may be configured to use a diffraction grating constituted by a volume hologram, like the transparent substrate 4 illustrated in FIGS. 1A and 1B. The light beam introduction optical system 70 may be configured to omit the quarter-wavelength plate 74 and use a half prism, for example, instead of the polarizing beam splitter 73.

### INDUSTRIAL APPLICABILITY

As described above, a display apparatus according to this disclosure is small and thin while having high optical performance and is therefore useful.

1. A display apparatus comprising:
a spatial phase modulator configured to form a display light beam;
a transparent substrate, the display light beam propagating in the transparent substrate by repeated internal reflection;
a bifurcation configured to emit a portion of the display light beam outside the transparent substrate each time the display light beam undergoes the internal reflection; and
a light beam introduction optical system including a beam splitter configured to guide an illumination light beam to the spatial phase modulator and to guide the display light beam formed by the spatial phase modulator to the transparent substrate; wherein
the spatial phase modulator forms the display light beam holographically by diffraction of the illumination light beam; and
the light beam introduction optical system further includes an optical element with a negative lens power in an optical path of the display light beam between the spatial phase modulator and the transparent substrate.

2. A display apparatus comprising:
a spatial phase modulator configured to form a display light beam;
a transparent substrate, the display light beam propagating in the transparent substrate by repeated internal reflection;
a bifurcation configured to emit a portion of the display light beam outside the transparent substrate each time the display light beam undergoes the internal reflection; and
a light beam introduction optical system including a beam splitter configured to guide an illumination light beam to the spatial phase modulator and to guide the display light beam formed by the spatial phase modulator to the transparent substrate; wherein
the spatial phase modulator forms the display light beam holographically by diffraction of the illumination light beam; and
the light beam introduction optical system has a negative lens power in an optical path of the display light beam between the spatial phase modulator and the transparent substrate.

3. A display apparatus comprising:
a spatial phase modulator configured to form a display light beam;
a transparent substrate, the display light beam propagating in the transparent substrate by repeated internal reflection;
a bifurcation configured to emit a portion of the display light beam outside the transparent substrate each time the display light beam undergoes the internal reflection; and
a light beam introduction optical system including a beam splitter configured to guide an illumination light beam to the spatial phase modulator and to guide the display light beam formed by the spatial phase modulator to the transparent substrate; wherein
the spatial phase modulator forms the display light beam holographically by diffraction of the illumination light beam;
the beam splitter comprises a polarizing beam splitter; and
the light beam introduction optical system further includes a quarter-wavelength plate between the polarizing beam splitter and the spatial phase modulator.

4. The display apparatus of claim 1, wherein the light beam introduction optical system causes the illumination light beam to be incident on the spatial phase modulator by inclining a central light ray of the illumination light beam relative to a normal to the spatial phase modulator.

5. A display apparatus comprising:
a spatial phase modulator configured to form a display light beam;
a transparent substrate, the display light beam propagating in the transparent substrate by repeated internal reflection;
a bifurcation configured to emit a portion of the display light beam outside the transparent substrate each time the display light beam undergoes the internal reflection; and
a light beam introduction optical system including a beam splitter configured to guide an illumination light beam to the spatial phase modulator and to guide the display light beam formed by the spatial phase modulator to the transparent substrate; wherein
the spatial phase modulator forms the display light beam holographically by diffraction of the illumination light beam;
the light beam introduction optical system causes the light beam to be incident on the spatial phase modulator by inclining a central light ray of the illumination light beam relative to a normal to the spatial phase modulator; and
an angle of reflection of zero-order light of the illumination light beam at the spatial phase modulator is greater than half of one display angle of view due to the display light beam.

6. The display apparatus of claim 3, wherein zero-order light of the illumination light beam at the spatial phase modulator is removed in a direction in which an angle of view is narrow.

7. A display apparatus comprising:
a spatial phase modulator configured to form a display light beam;
a transparent substrate, the display light beam propagating in the transparent substrate by repeated internal reflection;
a bifurcation configured to emit a portion of the display light beam outside the transparent substrate each time the display light beam undergoes the internal reflection; and
a light beam introduction optical system including a beam splitter configured to guide an illumination light beam to the spatial phase modulator and to guide the display light beam formed by the spatial phase modulator to the transparent substrate; wherein
the spatial phase modulator forms the display light beam holographically by diffraction of the illumination light beam; and
a coherence length of the display light beam is shorter than a distance of propagation of the display light beam due to undergoing the internal reflection once.

8. The display apparatus of claim 1, wherein the display light beam emitted outside the transparent substrate displays a virtual image at infinity.

9. The display apparatus of claim 1, wherein zero-order light and first-order light due to the spatial phase modulator are incident on transparent substrate under a condition of the zero-order light passing through the transparent substrate and the first-order light being totally reflected within the transparent substrate.

10. The display apparatus of claim 1, wherein the bifurcation comprises a diffraction grating.

11. The display apparatus of claim 10, wherein the diffraction grating comprises a volume hologram.

12. The display apparatus of claim 1, wherein the bifurcation comprises a prism array.

13. A display apparatus comprising:
a spatial phase modulator configured to form a display light beam;
a transparent substrate, the display light beam propagating in the transparent substrate by repeated internal reflection;
a bifurcation configured to emit a portion of the display light beam outside the transparent substrate each time the display light beam undergoes the internal reflection;
a light beam introduction optical system including a beam splitter configured to guide an illumination light beam to the spatial phase modulator and to guide the display light beam formed by the spatial phase modulator to the transparent substrate;
a second transparent substrate on which the display light beam emitted from the transparent substrate is incident, the display light beam propagating in the second transparent substrate by repeated internal reflection; and
a second bifurcation configured to emit a portion of the display light beam outside the second transparent substrate each time the display light beam undergoes the internal reflection in the second transparent substrate; wherein
the spatial phase modulator forms the display light beam holographically by diffraction of the illumination light beam.
